(19) United States
(12) Patent Application Publication
(10) Pub. No.: US 2002/0040670 A1
(43) Pub. Date: Apr. 11, 2002

(54) Seed carrier apparatus and method of use

(76) Inventor: Kathy E. Hornak, Sugarland, TX (US)

Correspondence Address: STEVEN, DAVIS, MILLER & MOSHER, L.L.P., Suite #850, 1615 L. Street N.W., Washington, DC, 20036-5622, US

(21) Appl. No.: 09/970,806

(22) Filed: Oct. 5, 2001

(30) Foreign Application Priority Data
Oct. 5, 2000 (US) 60/237726

(51) Int. Cl. A01G 9/02; A01G 23/02; A01C 11/00; A01C 1/00

(52) U.S. Cl. 111/114; 111/200; 111/900; 47/66.7; 47/73

(57) ABSTRACT

The invention is an apparatus including a seed carrier of a fibrous material, and at least one seed embedded within the seed carrier. The seed(s) and seed carrier are integrally formed with one another. The invention is also a method of planting, including the steps of providing at least one seed, and creating a seed carrier composed of a fibrous matter. Additionally, the inventive method includes the steps of embedding the seed(s) within the seed carrier such that the seeds become integrally formed into the seed carrier.

### BACKGROUND OF THE INVENTION

1. Field of the Invention

This invention relates generally to a seed carrier apparatus and a method of planting. More specifically, the invention relates to the field of death care, more specifically to the field of funeral services, still more specifically to cards, keepsakes, memorials or favors distributed at funeral-related events.

2. Description of Related Art

Keepsakes, favors, mementos, forget-me-nots, tokens and cards are often given away by hosts of parties, weddings, bar mitzvahs and the like in order to commemorate or validate the occurrence. However, at funerals and funeral-related events, such as wakes, memorial services or other gatherings recalling the deceased, the death care industry has not used the provision of keepsakes, partly because gift and card giving are associated with celebration, not mourning.

In contrast, flowers and plants have long been associated with funerals and visiting graves, partly due to the fact that flowers and plants symbolize life and thereby express the giver's remembrance of the deceased's life or even a wish to see the deceased alive again. See, e.g., Wilson Rawls' Where the Red Fern Grows. Distributing potted flowers or plants to funeral attendees, however, is often impractical or overly burdensome for the grieving party.

It can be appreciated that there exists a continuing need for keepsakes or favors that are appropriate at funeral-related events. In this regard, the present invention substantially fulfills this need.

### SUMMARY OF THE INVENTION

The invention is an apparatus comprising a seed carrier, preferably made of a fibrous material, and at least one seed embedded within the seed carrier. The seeds and seed carrier are integrally formed with one another. Additionally, the invention is directed to a method of distributing cards, mementos and other memorabilia together with the seeds and seed carrier at a funeral, wake or other memorial service for a deceased, and subsequent planting of the seeds and carrier, including the steps of removing at least one seed and seed carrier from the card, memento, or memorabilia. Preferably, the seeds should be integrally formed into the seed carrier. The seed carrier can merely be a substrate for the seeds, or itself may comprise a nutrient source for the seeds when the seeds and carrier are subsequently placed in the soil.

The inventive apparatus may take the from of a keepsake with seeds incorporated therein. After planting the portion of the keepsake containing the seeds, the seeds bloom into wildflowers or the like and serve as a vivid, uplifting and lasting reminder of the deceased.

In a preferred embodiment, the invention comprises a printable substrate, such as card stock or a greeting card, in combination with a seed carrier, and a method of distributing same at funeral-related events. The printable substrate has a substantially flat surface upon which a message and/or a picture of the deceased can be printed or affixed.

The seed carrier contains seeds embedded in a material that is capable of securely retaining seeds yet amenable to the growth of seedlings. Preferably, the entire seed carrier, with seeds embedded therein, may be planted in the ground. An example of such a material is a substantially planar, heart-shaped wafer of dried paper pulp, cotton or the like.

The seed carrier may be affixed to the printable substrate by means of an adhesive, tape, a fastener (such as a staple) or by being impressed into the printable substrate. In a preferred embodiment, the seed carrier has a substantially flat surface that adheres to a substantially flat surface of the printable substrate by means of a flexible adhesive. When affixed, the seed carrier lies adjacent to the printed message or picture on the printable substrate.

In a more preferred embodiment, the seed carrier comprises a substantially flat, polygonal or heart-shaped wafer of dried paper pulp that also contains decorative elements, such a bits and pieces of flowers, leaves, colored plant nutrients, or other parts of plants interspersed throughout the seed carrier, resulting in an aesthetically pleasing speckling of colors and shapes.

In a still further preferred embodiment, the seed carrier adheres to the printable substrate to create a temporary or loose bond. As such, the seed carrier may be removed from the printable substrate and plated in soil, and the printable substrate kept as a memento.

In another embodiment, the keepsakes are dispensed from a container, such as a lidded box decorated with a floral motif.

In another embodiment, the seed carrier contains or is enriched by a fertilizing substance, such as nitrogen compounds or other residue of organic matter. In other embodiments, the seed carrier assumes the shape of a star, a bell, a butterfly, a star of David, a cross, an ankh, a candle, a flower, a bird or a chai, the Hebrew symbol for life.

In other embodiments, the seed carrier may assume the shape of military or civilian insignia, such as rank, lodge, fraternal or other civic organization, international symbols, such as the Red Cross or the United Nations flag, or other designs associated with the deceased. In still other embodiments, the seeds are domesticated flower seeds, fern seeds or the seeds of other plants, including natural or genetically engineered seeds.

Other objects, features and advantages of the present invention will become more apparent from the following detailed description of the preferred embodiments and the accompanying drawing.

### BRIEF DESCRIPTION OF THE DRAWINGS

FIG. 1 is a perspective front view of a preferred keepsake comprising a printable substrate in combination with a seed carrier.

### DESCRIPTION OF THE PREFERRED EMBODIMENTS

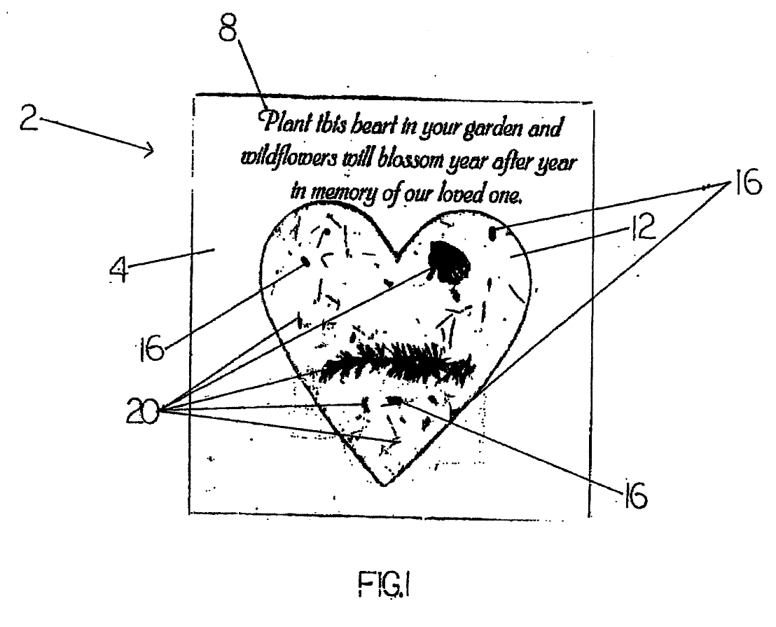

FIG. 1 depicts a keepsake 2 comprising a printable substrate 4, specifically, a card with a message 8 regarding a deceased. It may also include an impressed, printed or sketched likeness of the deceased or a photograph. Printable substrate 4 is preferably made of conventional card-making material, such as cardstock paper. White and ivory are preferred colors.

FIG. 1 also depicts a seed carrier 12, specifically, a substantially flat, heart-shaped carrier for the seeds, such as a wafer of dried paper pulp containing wildflower seeds 16, or any seeds from flowering or blooming plants. Note that all seeds 16 may not be visible from the surface of seed carrier 12. Seed carrier 12 also contains bits and pieces of flowers and plants 20 interspersed throughout, resulting in a variety of attractive colors and shapes. Bits and pieces 20 that are bright in color or that resemble miniature fern leaves or pine needles are preferred.

The seed carrier 12 is preferably made of a paper pulp, cotton or a similar material that is fibrous, soft, breathes well, and is disintegratable, water soluble, biodegradable and breathes well. These properties allow it to both securely contain seeds 16 and to facilitate their growth, such that seed carrier 12 may be planted along with seeds 16, i.e., the keepsake recipient need not remove seeds 16 from seed carrier 12 before planting them. These properties also allow bits and pieces 20 to dry readily.

In this preferred embodiment, the adhesive bond that binds seed carrier 12 to printable substrate 4 is weak and seed carrier 12 can be easily separated from printable substrate 4, such that both seed carrier 12 and printable substrate 4 remain intact after separation and the latter may be kept as a memento.

In another embodiment, seed carrier 12 contains or is enriched by a fertilizing substance, such as nitrogen compounds. In other embodiments (not shown), seed carrier 12 assumes the shape of a star, a bell, a butterfly, a star of David, a cross, an ankh, a candle, a bird, a flower or a chai, the Hebrew symbol for life, or other insignia as disclosed above. In still other embodiments, the seeds are domesticated flower seeds, fern seeds or the seeds of other plants, both naturally occurring and genetically engineered.

A preferred method of the invention comprises distribution of the preferred keepsake at or in connection with a funeral-related event. In the most preferred method, the keepsakes 2 are dispensed at the wake or similar event from a container, such as a box with an openable lid, the box and box lid being decorated with a floral motif, kept open on a table near an exit or entrance of the church, synagogue, mosque, funeral home or other place of service, including the grave site.

Additionally, the seed carrier may be integrally formed into a card stock, such as a greeting card. In this embodiment, the seeds are embedded between adjacent fibers of the card stock, and a perimeter of the seed carrier is perforated so that the seed carrier may be removed from the remainder of the card stock.

It should be understood that the foregoing summary, detailed description, examples and drawings of the invention are not intended to be limiting, but are only exemplary of the inventive features. The scope of the invention shall be limited only by the appended claims.

I claim:

1. An apparatus, comprising:
a seed carrier composed of a fabricated substrate;
at least one seed embedded within the seed carrier,
the at least one seed and seed carrier being integrally formed with one another.

2. The apparatus of claim 1, wherein the seed carrier is one of fabric or paper.

3. The apparatus of claim 1, wherein the seed carrier is cotton.

4. The apparatus of claim 1, wherein the seed carrier comprises at least two layers, and the at least one seed is positioned between adjacent layers.

5. The apparatus of claim 1, further comprising a decorative element embedded within the seed carrier.

6. The apparatus of claim 1, further comprising a printed card; and,
wherein the seed carrier is affixed to the printed card.

7. The apparatus of claim 1, wherein the seeds are the seeds of flowering or blooming plants.

8. The apparatus of claim 1, wherein the seed carrier is treated with plant nutrients.

9. The apparatus of claim 1, wherein the seed carrier is one of a polygonal shape, a religious symbol, or a heart.

10. A method of planting, comprising the steps of:
providing at least one seed for growing plants;
creating a seed carrier composed of a fibrous matter;
embedding the at least one seed within the seed carrier such that the seeds become integrally formed into the seed carrier; and
placing the seed carrier into soil.

12. A method of planting as in claim 11, wherein the seed carrier comprises at least two layers, and the at least one seed is placed between adjacent layers during the embedding step.

13. A method of planting as in claim 11, further comprising the step of impregnating the seed carrier with decorative material.

14. A method of planting as in claim 11, further comprising the step of
providing a card stock; and,
affixing the seed carrier to the card stock.

15. The method of claim 14, wherein the card stock comprises a greeting card.

16. The method of claim 11, further comprising the step of cutting the seed carrier into a preselected shape.

17. The method of claim 16, wherein the shape is one of a heart, circle, polygon, cross, or star.

18. The method of claim 16, wherein the preselected shape is a religious symbol.

19. The method of claim 11, further comprising the steps of:
providing a card stock;
removably integrating the seed carrier into the card stock;
removing the seed carrier from card stock.

20. Keepsakes to be distributed at a memorial or funeral service for a deceased person, comprising:
a cardstock printed with a remembrance of the deceased person;
at least one seed of a blooming or flowering plant integrated with said cardstock.
